(19) United States
(12) Patent Application Publication
(10) Pub. No.: US 2001/0052190 A1
(43) Pub. Date: Dec. 20, 2001

(54) Space configuration design tool

(76) Inventor: Susan M. Duncan, Auburn, WA (US)

Correspondence Address: David A. Lowe, Esq., BLACK LOWE & GRAHAM PLLC, 816 Second Avenue, Seattle, WA, 98104, US

(21) Appl. No.: 09/881,856

(22) Filed: Jun. 13, 2001

Related U.S. Application Data
(60) Provisional application No. 60/212,381, filed on Jun. 14, 2000.

(51) Int. Cl. G01D 21/00

(52) U.S. Cl. 33/613

(57) ABSTRACT

A design tool comprises an icon figure attached to a base. The icon figure is shaped as a human seated in a wheelchair, although the shape of the icon figure is constrained only by size requirements necessary to allow it to function as a design tool in a particular application. The base is shaped and scaled to imitate the turning radius of a wheelchair. In an alternative embodiment, the base may have a different shape or size to indicate a different turning radius. The design tool further comprises a rod or wand extending from and supporting the icon figure in operation, providing an alternative way for the user to maneuver the icon figure and base. In operation, manipulation of the design tool along pathways on a design plan visually illustrates the feasibility of movement along the noted paths in light of the size and turning radius of the represented person.

### PRIORITY CLAIM

This application claims priority from U.S. Provisional application Ser. No. 60/212,381 filed Jun. 14, 2000, Attorney Reference No. ADAP-1-1001.

### FIELD OF THE INVENTION

This invention relates generally to design tools and, more specifically, to design tools for functional and space planning in the fields of architecture, interior design, and construction of residential and commercial structures.

### BACKGROUND OF THE INVENTION

Professionals in the fields of architecture, design, manufacturing, and construction, as well as building code officials and similar types of oversight personnel, have had very limited support in terms of tools necessary to plan effective accessible layouts. The challenge is to design residential and commercial space to support the accessibility needs of persons with disabilities and the aging population. Building designers, contractors, and oversight personnel must be able to efficiently and effectively configure interior space as well as access into and out of building structures to provide for these special needs.

Various design tools have been used to attempt to accomplish this goal, including an architectural scale, a template, and an overlay of a wheelchair icon. These tools allow the professional to indicate a wheelchair location on a floor or design plan (commercial or residential to scale in ⅛″, ¼″, ½″) by placement of the overlay on the design plan. A significant disadvantage with current systems is that a mark or indication on a design plan does not demonstrate and visually describe the actual movement of a wheelchair or other types of mobility equipment as it negotiates the space. As a result, errors are frequently made in the resulting design or construction due to a lack of understanding as to how a person uses a wheelchair and the space required in which to maneuver the wheelchair.

Thus, there is a need for a design tool that addresses the disadvantages associated with current functional and space planning design tools.

### SUMMARY OF THE INVENTION

The present invention is a design tool for use in association with design plans having hallways, doorways, stairways, rooms and other spaces of a known scale, for functional and space planning in the fields of architecture, interior design, and construction of residential and commercial structures. The design tool comprising a member having a first surface and a second surface, the second surface engageable with the design plans, the member scaled to indicate a turning radius to imitate the turning radius of a support device used by persons with disabilities and the aging population.

In an alternative embodiment, the design tool further comprises an icon figure attached to the first surface of the member, the icon figure sized to the scale of the design plans to allow accurate representation of the movement of persons with disabilities and the aging population along the hallways, doorways, stairways, rooms and other spaces of the design plan to visually illustrate the feasibility of movement along the noted paths in light of the size and turning radius of the represented person.

In an alternative embodiment, the design tool member or the icon figure is shaped as a human seated in a wheelchair, and includes an upper torso portion, a lower torso portion, a head portion, and a wheelchair portion having wheels on both sides of the seated human shape and a chair back at the rear of the human shape.

In still an alternative embodiment, the base has a diameter equal to or greater than the diameter of the icon figure.

In yet an alternative embodiment, the design tool further comprising a wand extending from and supporting the member in operation of the design tool, the wand having a first end and a second end.

In an alternative embodiment, the icon figure includes an opening having an upper end and a base, the opening corresponds in size to the first end of the wand, and the first end of the wand is maintained within the opening of the icon figure. In yet an alternative embodiment, the first end of the wand is maintained within the opening of the icon figure by frictional contact of the first end of the wand to the interior of the opening. In still another embodiment, the icon figure includes a metal plate located at the base of the opening, the first end of the wand includes a magnet, and the wand is maintained within the opening of the icon figure by the metal plate-magnet combination. In yet another embodiment, the opening of the icon figure includes first ridge members along the interior of the opening, the first end of the wand includes second ridge members corresponding to the first ridge members along the interior of the opening, and the wand is maintained within the opening of the icon figure by the snap-lock combination between the first and second ridge members.

### BRIEF DESCRIPTION OF THE DRAWINGS

The preferred and alternative embodiments of the present invention are described in detail below with reference to the following drawings.

FIG. 1 is an isometric view of a design tool in accordance with the present invention, including a supporting wand.

FIG. 2 is an isometric view of the design tool without the supporting wand.

FIG. 3 is a top view of the design tool.

FIG. 4 is a back view of the design tool showing the insertion point for the wand.

FIG. 5 is a sectional view taken substantially along the plane of the line 5-5 of FIG. 4.

FIG. 6 is an isometric view of the design tool with the supporting wand in association with an architectural space layout or floor plan.

FIG. 7 is an isometric view of design tool packaging.

### DETAILED DESCRIPTION OF THE PREFERRED EMBODIMENT

The preferred embodiment of the present invention provides a tool to allow a designer, contractor, or oversight reviewer to see a human icon figure seated in a wheelchair in 3-dimensions maneuvering through a design plan. The present invention offers significant advantages in the design and construction of residential and commercial space.

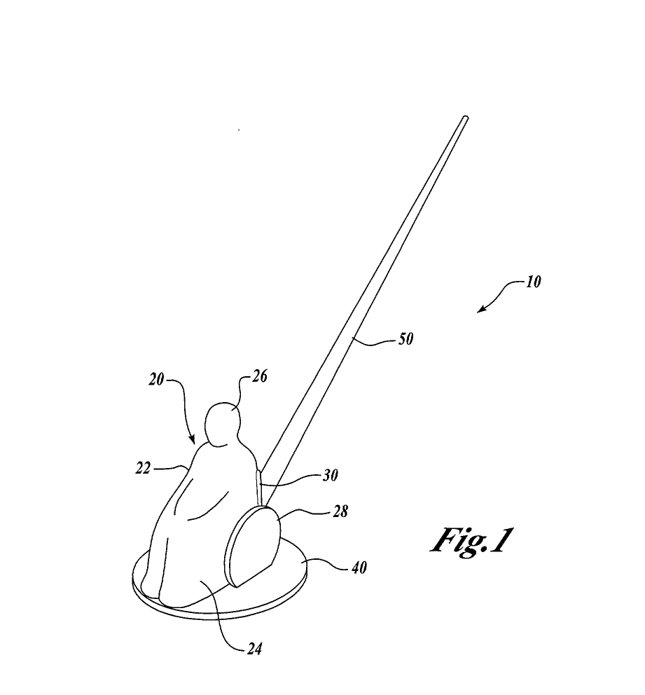

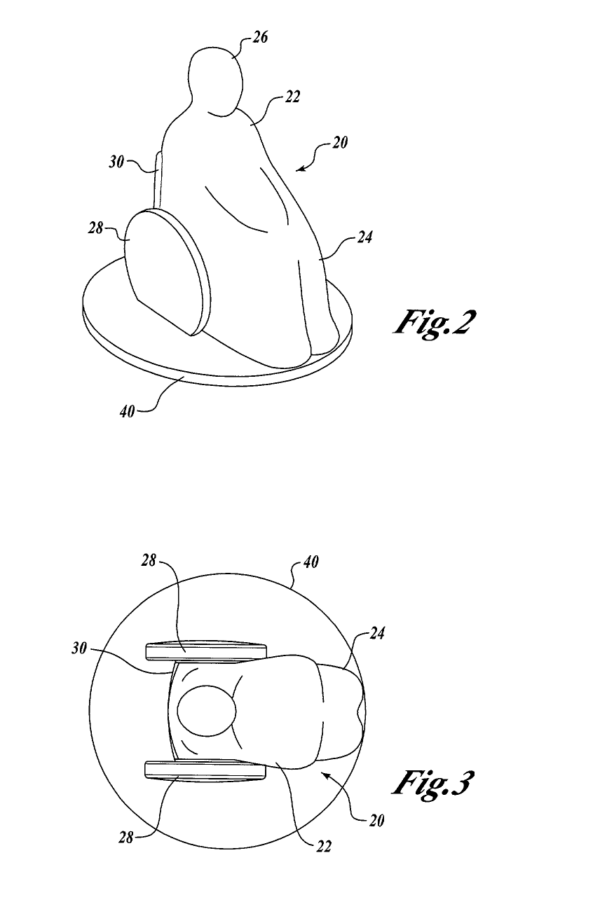

Referring to FIGS. 1 and 2, a design tool 10 comprises an icon FIG. 20 attached to a base 40. In the preferred embodiment, the design tool further comprises a rod or wand 50 extending from and supporting the icon figure in operation. The wand provides another way for the user to maneuver the icon figure and base should holding and pushing the icon figure be inadequate.

In the preferred embodiment of the present invention, the icon figure is shaped as a human seated in a wheelchair. Specifically, the human shape of icon FIG. 20 includes upper torso 22, lower torso 24, and head 26. The wheelchair shape of icon FIG. 20 includes wheels 28 on both sides of the seated human shape and chair back 30 at the rear of the human shape. It will be appreciated that the icon figure can be made to various shapes and sizes as dictated by the type and size of space design under consideration and the disability at issue, and may or may not include a human or wheelchair shape. The shape of the icon figure, while serving to communicate a preferable use of the design tool, is therefore largely constrained only by size requirements necessary to allow it to function as a space design tool in a particular application. In the preferred embodiment, the icon figures are made to scale, for example, ⅛″, ¼″ and ½″ (or equivalent metric or other scale).

Icon FIG. 20 is preferably injection molded as a single-piece item, although it may be formed out of various components (for example, a human icon figure and a fitted wheelchair structure) held together by a variety of different means, including glue, tape, screws, etc. The icon figure may be made out of various materials. In a preferred embodiment, the material used is either Santoprene or Pellathane. The icon figure may be produced in a variety of colors, although solid colors that contrast with traditional blue design plans are preferable as they are more easily seen by the users. The icon figure is stable and counter-balanced so that it does not tip over when moved. This becomes more important as the size of the icon figure grows. Necessary counter-balancing is preferably accomplished by use of properly sized and located metal plates molded into the icon figure, although it will be appreciated that counter-balancing can be accomplished in a number of different ways, such as the incorporation of more material as part of the icon figure.

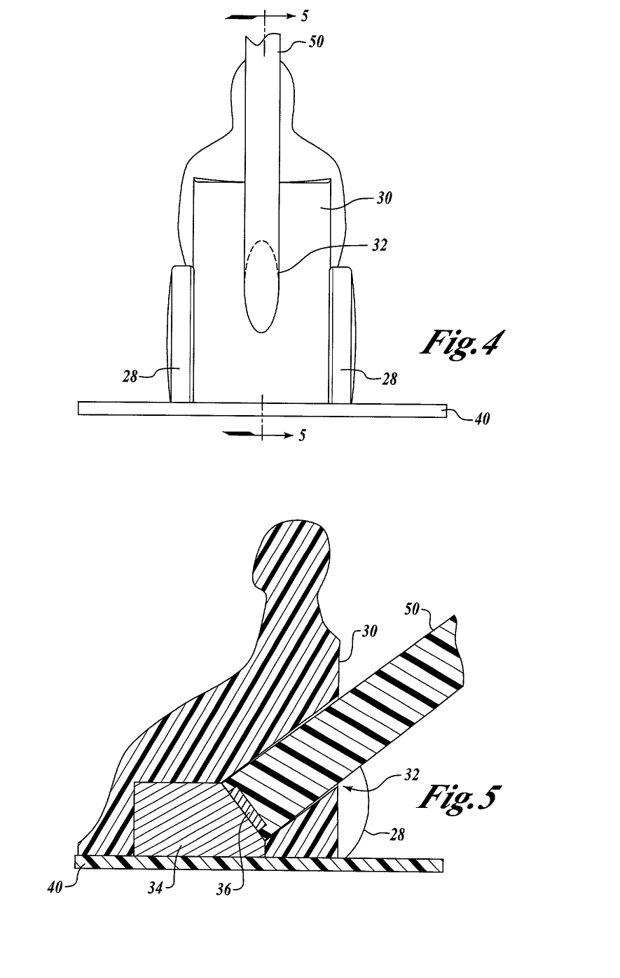

With further reference to FIG. 3, icon FIG. 20 is mounted, either permanently or removably, to base 40. The base is preferably made of clear material, for example Lucite-type material, such as Polypropylene or ABS, and is scaled to indicate a turning radius to imitate the turning radius of a wheelchair. In an alternative embodiment, the base may have a different shape or size to indicate a different turning radius. The use of a clear plastic base is preferable as it allows the user to see a greater amount of the design plan when the design tool is in operation.

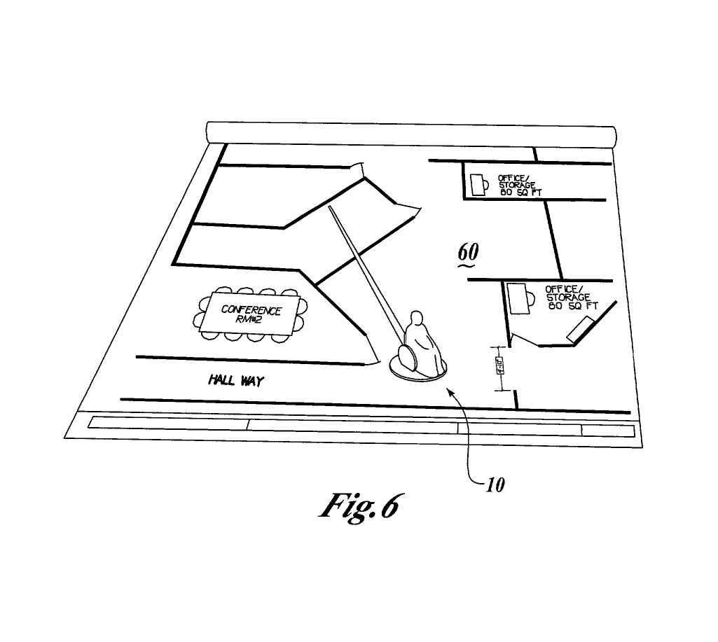

To facilitate movement of the icon figure and clear plastic base and use of the tool with design plans, each icon figure is formed with an opening 32 to receive rod or wand 50. As shown with reference to FIGS. 4 and 5, the opening is preferably located at the rear of icon FIG. 20, specifically in the back of chair 30. As the size of the icon figure permits, such as with the ¼″ and ½″ scale icon figures in the preferred embodiment, a metal plate 34 is placed at the interior base of the tapered opening in the icon figure. The metal plate may be used as the counter-balance described above, as well as to maintain the wand in opening 32, as described below.

As shown with specific reference to FIGS. 1, 4 and 5, wand 50 of the design tool is preferably made out of molded plastic, is oval shaped (for added structural strength), and is sized to allow a user to comfortably hold one end of the wand while supporting movement of the icon figure and base as it is used with a design plan. In the preferred embodiment, the wand is tapered and the opening is correspondingly tapered to receive one end of the wand. It will be appreciated that the wand may be made out of different materials, and may vary in specific shape and size, so long as it functions to support the weight of the icon figure and allows comfortable usage. More specifically, one end of wand 50 is inserted into opening 32 of chair back 30 of icon FIG. 20. The wand is maintained in the opening in a variety of ways. In the preferred embodiment, with the larger scale icon figures, one end of the wand includes a magnet. The end of the wand with the magnet is inserted into opening 32 against metal plate 34, thereby removably connecting the wand to the icon figure. Alternatively, the wand may be maintained in the opening of the icon figure by frictional contact of the wand to the interior of the opening. For example, due to size restrictions, the ⅛″ scale icon figure has a smaller tapered wand and does not use a metal plate-magnet combination, relying on frictional contact. Further alternative means of maintaining the wand in the opening to support the icon figure and the base are contemplated. For example, the end of the wand to be inserted into the opening could further include ridges or locks corresponding to ridges or locks located within the opening. In such an embodiment, the wand is snap-fit into place to secure the wand during operation, yet can, upon use of additional applied force, be removed from the icon figure for transportation or storage. The wand may also be held in place in a permanent fashion by use of, for example, glue, or a screw extending from one end of the wand into the body of the icon figure. Regardless of the particular embodiment, the wand remains in place when the user releases the wand during operation.

The operation of the design tool is better understood by reference to FIG. 6. FIG. 6 shows preferred design tool 10 as used in conjunction with a design plan 60. A design tool, appropriately sized to the scale of the design plan, is moved by the user along the hallways, through doorways, and in office and other room spaces, either by holding and pushing the icon figure and base directly, or by manipulating the icon figure and base using the accompanying wand. Manipulation of the design tool along these pathways visually illustrates the feasibility of movement along the noted paths in light of the size and turning radius of the represented person. In the preferred embodiment shown, using the design tool, the user is able to evaluate and eventually design appropriately sized plan configurations to meet the special needs of persons with disabilities and the aging population, such as the size and configuration of rooms, doorways and stairways to provide appropriate wheelchair access.

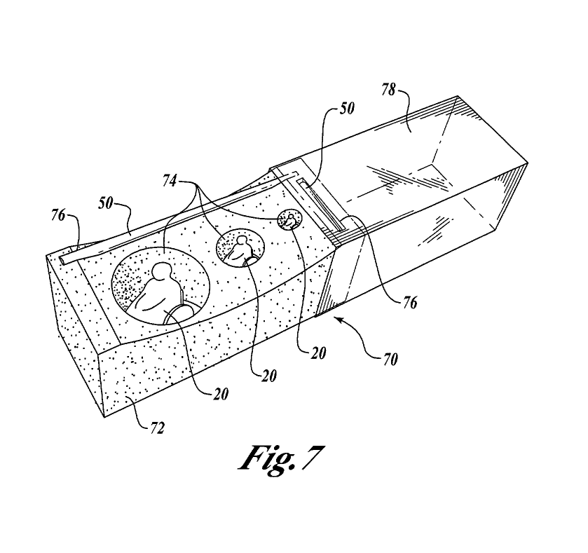

As better understood with reference to FIG. 7, an alternative embodiment of the present invention provides design tool packaging 70 in association with the design tool, including the wand. Design tool packaging 70 comprises pliable support structure 72, preferably made from Urethane foam, out of which one or more holes 74 and 76 are cut. Each hole 74 is sized to receive a scaled icon figure and corresponding base so as to prominently display the icon figure outwards from support structure 72. Each hole 76 is sized to receive a corresponding wand. The design tool packaging is slidably encased by an exterior translucent film material 76, preferably polycarbonate film. When in use around the design tool packaging, the film material maintains the design tool, including wand, securely within the design tool packaging, and protects the design tool and wand, while at the same time providing convenient viewing of the packaging contents.

While the preferred embodiment of the invention has been illustrated and described, as noted above, many changes can be made without departing from the spirit and scope of the invention. For example, the icon figure and base could be merged into a single piece. In addition, the design tool could be fitted with one or more metal plates or magnets and moved according to magnetic attraction between the metal plates and magnets and a metal plate or magnet separate from the design tool. It is likewise contemplated that the design tool could be automated to move according to a programmed pattern without a manual interface, such as part of a computer routine, or through use of remote controlled operation. Accordingly, the scope of the invention is not limited by the disclosure of the preferred embodiment. Instead, the invention should be determined entirely by reference to the claims that follow.

The embodiments of the invention in which an exclusive property or privilege is claimed are defined as follows:

1. A design tool for use in association with design plans having hallways, doorways, stairways, rooms and other spaces of a known scale, for functional and space planning in the fields of architecture, interior design, and construction of residential and commercial structures, comprising a member having a first surface and a second surface, the second surface engageable with the design plans, the member scaled to indicate a turning radius to imitate the turning radius of a support device used by persons with disabilities and the aging population.

2. The design tool of claim 1, wherein the member is shaped as a human seated in a wheelchair, and includes an upper torso portion, a lower torso portion, a head portion, and a wheelchair portion having wheels on both sides of the human shape and a chair back at the rear of the human shape.

3. The design tool of claim 1, further comprising a wand extending from and supporting the member in operation of the design tool, the wand having a first end and a second end.

4. A design tool for use in association with design plans having hallways, doorways, stairways, rooms and other spaces of a known scale, for functional and space planning in the fields of architecture, interior design, and construction of residential and commercial structures, comprising a member having a first surface and a second surface, the second surface engageable with the design plans, the member scaled to indicate a turning radius to imitate the turning radius of a support device used by persons with disabilities and the aging population, and a wand extending from and supporting the member in operation of the design tool.

5. The design tool of claim 4, wherein the icon figure is shaped as a human seated in a wheelchair, and includes an upper torso portion, a lower torso portion, a head portion, and a wheelchair portion having wheels on both sides of the human shape and a chair back at the rear of the human shape.

6. A design tool for use in association with design plans having hallways, doorways, stairways, rooms and other spaces of a known scale, for functional and space planning in the fields of architecture, interior design, and construction of residential and commercial structures, comprising a base having a first surface and a second surface, the second surface engageable with the design plans, the base scaled to indicate a turning radius to imitate the turning radius of a support device used by persons with disabilities and the aging population, and an icon figure attached to the first surface of the base, the icon figure sized to the scale of the design plans to allow accurate representation of the movement of persons with disabilities and the aging population along the hallways, doorways, stairways, rooms and other spaces of the design plan to visually illustrate the feasibility of movement along the noted paths in light of the size and turning radius of the represented person.

7. The design tool of claim 6, further comprising a wand extending from and supporting the icon figure in operation of the design tool, the wand having a first end and a second end.

8. The design tool of claim 7, wherein the icon figure includes an opening having an upper end and a base, the opening corresponds in size to the first end of the wand, and the first end of the wand is maintained within the opening of the icon figure.

9. The design tool of claim 8, wherein the first end of the wand is maintained within the opening of the icon figure by frictional contact of the first end of the wand to the interior of the opening.

10. The design tool of claim 8, wherein the icon figure includes a metal plate located at the base of the opening, the first end of the wand includes a magnet, and the wand is maintained within the opening of the icon figure by the metal place-magnet combination.

11. The design tool of claim 8, wherein the opening of the icon figure includes first ridge members along the interior of the opening, the first end of the wand includes second ridge members corresponding to the first ridge members along the interior of the opening, and the wand is maintained within the opening of the icon figure by the snap-lock combination between the first and second ridge members.

12. The design tool of claim 6, wherein the base has a diameter equal to or greater than the diameter of the icon figure.

13. The design tool of claim 6, wherein the icon figure is shaped as a human seated in a wheelchair, and includes an upper torso portion, a lower torso portion, a head portion, and a wheelchair portion having wheels on both sides of the human shape and a chair back at the rear of the human shape.

14. A design tool for use in association with design plans having hallways, doorways, stairways, rooms and other spaces of a known scale, for functional and space planning in the fields of architecture, interior design, and construction of residential and commercial structures, comprising:
a base having a first surface and a second surface, the second surface engageable with the design plans, the base scaled to indicate a turning radius to imitate the turning radius of a support device used by persons with disabilities and the aging population;
an icon figure attached to the first surface of the base, the icon figure sized to the scale of the design plans to allow accurate representation of the movement of persons with disabilities and the aging population along the hallways, doorways, stairways, rooms and other spaces of the design plan to visually illustrate the feasibility of movement along the noted paths in light of the size and turning radius of the represented person; and
a wand extending from and supporting the icon figure in operation of the design tool, the wand having a first end and a second end.

15. The design tool of claim 14, wherein the icon figure includes an opening having an upper end and a base, the opening corresponds in size to the first end of the wand, and the first end of the wand is maintained within the opening of the icon figure.

16. The design tool of claim 15, wherein the first end of the wand is maintained within the opening of the icon figure by frictional contact of the first end of the wand to the interior of the opening.

17. The design tool of claim 15, wherein the icon figure includes a metal plate located at the base of the opening, the first end of the wand includes a magnet, and the wand is maintained within the opening of the icon figure by the metal place-magnet combination.

18. The design tool of claim 15, wherein the opening of the icon figure includes first ridge members along the interior of the opening, the first end of the wand includes second ridge members corresponding to the first ridge members along the interior of the opening, and the wand is maintained within the opening of the icon figure by the snap-lock combination between the first and second ridge members.

19. The design tool of claim 14, wherein the base has a diameter equal to or greater than the diameter of the icon figure.

20. The design tool of claim 14, wherein the icon figure is shaped as a human seated in a wheelchair, and includes an upper torso portion, a lower torso portion, a head portion, and a wheelchair portion having wheels on both sides of the human shape and a chair back at the rear of the human shape.

21. A design tool for use in association with design plans having hallways, doorways, stairways, rooms and other spaces of a known scale, for functional and space planning in the fields of architecture, interior design, and construction of residential and commercial structures, comprising a means engageable with the design plans and scaled to indicate a turning radius to imitate the turning radius of a support device used by persons with disabilities and the aging population.

22. A design tool for use in association with design plans having hallways, doorways, stairways, rooms and other spaces of a known scale, for functional and space planning in the fields of architecture, interior design, and construction of residential and commercial structures, comprising a member means engageable with the design plans and scaled to indicate a turning radius to imitate the turning radius of a support device used by persons with disabilities and the aging population, and a means for supporting the member means in operation of the design tool.

23. A display package for use in association with a design tool having a scaled icon figure and corresponding base and used for functional and space planning in the fields of architecture, interior design, and construction of residential and commercial structures, comprising a support structure, a hole cut sized to receive the scaled icon figure and corresponding base so as to prominently display the icon figure outwards from the support structure, and an exterior cover into which the support structure is slidably encased for maintaining the design tool securely within the support structure.

24. The display package of claim 23, wherein the design tool further includes a wand extending from and supporting the icon figure and corresponding base and the support structure further comprises a hole cut sized to receive and prominently display the wand.
